(19) United States
(12) Patent Application Publication
(10) Pub. No.: US 2026/0193903 A1
(43) Pub. Date: Jul. 9, 2026

(54) DEADBOLT THUMB TURNPIECE POSITION SENSING

(71) Applicant: Hampton Products International Corporation, Foothill Ranch, CA (US)

(72) Inventor: Chasen Beck, Garden Grove, CA (US)

(21) Appl. No.: 19/012,565

(22) Filed: Jan. 7, 2025

(51) Int. Cl. E05B 47/00; E05B 9/02; E05B 63/00; G01D 5/14

(52) U.S. Cl. CPC E05B 47/0012; E05B 9/02; E05B 63/0017; G01D 5/145; E05B 2047/0017; E05B 2047/002; E05B 2047/0067; G01D 2205/24

(57) ABSTRACT

A component for a manually and electronically operable deadbolt assembly has a housing that includes a rotational shaft, which can be coupled to a deadbolt thumb turnpiece. The rotational shaft has a magnet. The magnet may be a pot magnet. The housing includes magnet sensors, arranged to sense the magnet of the rotational shaft. The magnet sensors can be Hall effect sensors.

### TECHNICAL FIELD

The technical field of the present disclosure relates to door locks, more specifically

deadbolt door locks, still more specifically manually and electronically operated deadbolt door locks.

### BACKGROUND

Deadbolt door locks and other types of door locks provide security for homes, businesses, owners and occupants thereof. Designers and manufacturers of door locks strive for security, durability, and also precision, repeatability and reliability of the product. Particularly, one class of deadbolt door locks is operable both manually and electronically, which poses even more challenges for aligning the two types of operations precisely, repeatably and reliably. For example, lack of precision in the electronics could make one of this class of deadbolt door locks less secure, less repeatable and/or less reliable than a purely mechanical deadbolt lock. There is an ongoing need in the art for technological improvement in this class of deadbolt door locks. It is in this environment that present embodiments arise.

### SUMMARY

Various embodiments are described herein, of components and a manually and electronically operable deadbolt assembly. Embodiments use magnet sensors and a magnet, and sense position of a rotational shaft. The rotational shaft may be coupled to a deadbolt, may be coupled to a deadbolt thumb turnpiece, and/or may be coupled to an electric motor. The magnet sensors may be Hall effect sensors. The magnet may be a pot magnet.

One embodiment is a component for a manually and electronically operable deadbolt assembly. The component includes a housing. The housing is dimensioned to assemble to an interior-facing side of a door, a deadbolt assembly, and an exterior-facing component, for forming the manually and electronically operable deadbolt assembly. The housing includes a rotational shaft having at least one magnet. The housing includes magnet sensors. The magnet sensors are arranged to sense the at least one magnet of the rotational shaft.

One embodiment is an interior-facing component for a manually and electronically operable deadbolt assembly. The component includes a housing. The housing is to assemble on an interior-facing side of a door to a deadbolt assembly, an exterior-facing component, and the door. The housing includes a rotational shaft that has a pot magnet. The rotational shaft is to couple to a deadbolt of the deadbolt assembly with operability to lock and unlock the door. The housing includes Hall effect sensors. The Hall effect sensors are arranged to sense the pot magnet and associated position of the rotational shaft.

One embodiment is a method of operation of a component for a manually and electronically operable deadbolt assembly. The method is practiced by the component. The method includes receiving rotation of a deadbolt thumb turnpiece that is rotatably mounted to a housing and coupled to a rotational shaft. The method includes rotating the rotational shaft, due to such coupling of the rotational shaft and the deadbolt thumb turnpiece, and due to such rotation of the deadbolt thumb turnpiece. The method includes detecting rotational positioning of the rotational shaft from the rotation of the deadbolt thumb turnpiece. The detecting is via magnetic field sensors arranged within the housing to sense a magnet of the rotational shaft.

Other aspects and advantages of the embodiments will become apparent from the following detailed description taken in conjunction with the accompanying drawings which illustrate, by way of example, the principles of the described embodiments.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 illustrates an embodiment of an interior-facing component for a manually and electronically operable deadbolt assembly, featuring a rotational shaft with a magnet, and sensors.

FIG. 2 illustrates a further view of the interior-facing component of FIG. 1, featuring a deadbolt thumb turnpiece, in an embodiment.

FIGS. 3-6 illustrate installation of a manually and electronically operable deadbolt assembly to a door.

FIG. 3 illustrates a deadbolt assembly, installed in a door, ready for installation of further components of a manually and electronically operable deadbolt assembly.

FIG. 4 illustrates an embodiment of an exterior-facing component for a manually and electronically operable deadbolt assembly, showing installation to the door and to the deadbolt assembly, of FIG. 3.

FIG. 5 illustrates a view of the interior-facing side of a door with portions of the deadbolt assembly of FIG. 3 and underside of the exterior-facing component of FIG. 4 visible, ready to receive installation of the interior-facing component of FIGS. 1 and 2.

FIG. 6 illustrates installation of the interior-facing component of FIGS. 1 and 2 to the door and other components, showing the deadbolt thumb turnpiece as accessible for manual operation of the deadbolt from the interior-facing side of the door.

FIG. 7 illustrates an embodiment of a method of operation of a component for a manually and electronically operable deadbolt assembly.

### DETAILED DESCRIPTION

Described herein are various embodiments of components of and for a manually and electronically operable deadbolt, also termed a manually and electronically operable deadbolt assembly. Included are embodiments of an exterior-facing component, an interior-facing component, and an example installation of a manually and electronically operable deadbolt assembly to a door. Of particular interest, and detail, various embodiments exhibit technological improvement in sensitivity, accuracy, repeatability and/or reliability in detecting or sensing rotational positioning of a rotational shaft that can be manually or electronically operated for moving a deadbolt, to lock and unlock a door.

Embodiments may combine some or all of the following features, or variations thereof. In some embodiments, Hall effect sensors are positioned at approximately 0, 90, and 180 degrees along the circumference of a unit circle on top of a circuit board. In some embodiments, a pot magnet is attached to a shaft of a thumb turnpiece to trigger the magnetic sensors at the 0°, 90° and 180° positions of shaft rotation. In various embodiments, the purpose and function of the pot magnet is to better focus the magnetic field lines for turnpiece position accuracy and finer resolution. In various embodiments, the lock position is at 0 or 180 degrees depending on whether the door is a left-hand swinging or right-hand swinging door.

Variations could include other types of magnetic sensors or magnetic field sensors. Variations could include various types of magnets such as permanent magnets of various materials, or even electromagnets. A pot magnet may have a steel shell, or be potted or embedded in steel, which concentrates magnetic field. Variations from a pot magnet could include various arrangements for magnets including attaching or fastening a magnet, e.g., in or to a portion of or a projection from the aforementioned shaft. Nonetheless, specific embodiments described herein may have specific advantages. For example, the Hall effect sensor may be a very accurate, repeatable and reliable type of magnetic sensor or magnetic field sensor. For example, a pot magnet made by embedding a magnet in a steel shaft may have superior mechanical reliability in comparison to other arrangements for magnets. Alignment of the concentrated magnetic field of a pot magnet to magnetic sensors at specified positions may optimize sensing of shaft position and rotation.

Variations may be devised by the person of skill in the art, in keeping with the teachings herein. Specific embodiments are described below, and it is understood that various features, variations thereof and combinations thereof may be combined in various further embodiments.

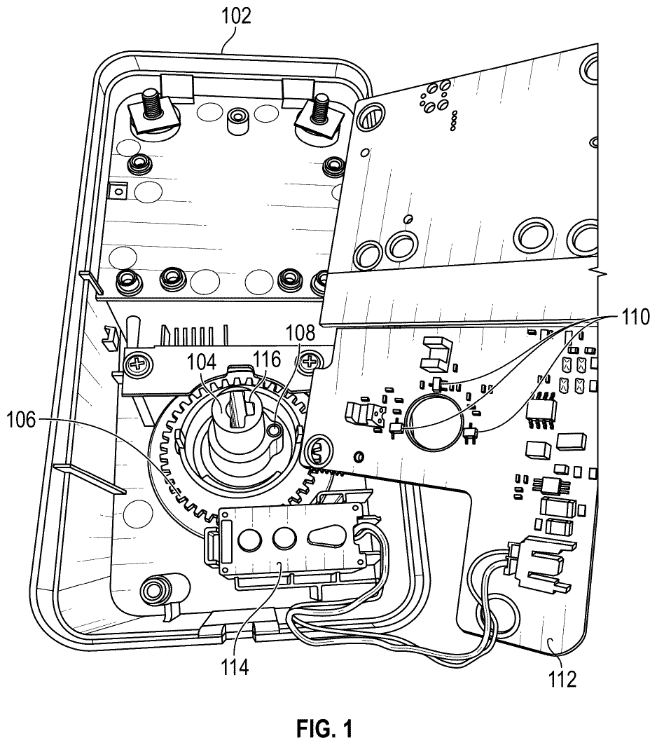

FIG. 1 illustrates an embodiment of an interior-facing component for a manually and electronically operable deadbolt assembly, featuring a rotational shaft 104 with a magnet 108, and sensors 110. Further features of an embodiment of a manually and electronically operable deadbolt assembly are further described below, while FIG. 1 concentrates on this specific interior-facing component and features thereof.

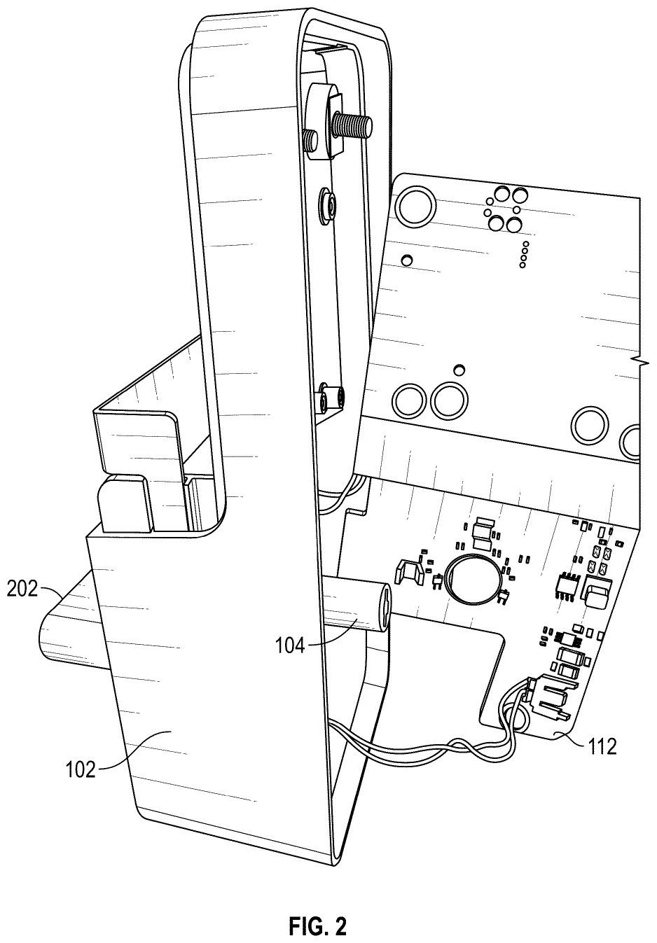

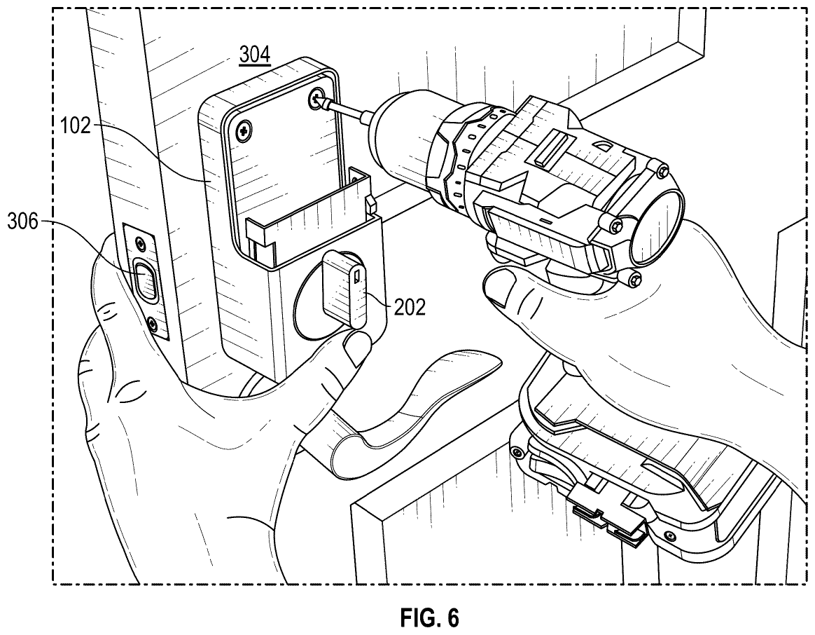

A housing 102, which may be made of metal and provide various mountings and surface features, has an interior (as shown in FIG. 1 and partially in FIG. 2) and an exterior (as shown partially in FIG. 2, see also FIG. 6). In the interior of the housing 102, the rotational shaft 104 is rotatably mounted, which could be termed a rotatable shaft mounting, and in this embodiment has a gear 106 that can be driven by a motor assembly 114 for rotating the rotational shaft 104. For example, the gear 106 could be attached to the rotational shaft 104 in a concentric arrangement, or formed integrally with the rotational shaft, e.g. by a casting or molding process. And, the motor assembly 114 could include a gear and a motor, i.e., a geared motor (not shown but readily understood), with the gear of the motor meshed with the gear 106 of the rotational shaft 104. It is further understood the motor of the motor assembly 114 could be of various types of electric motors, such as brushed or brushless, permanent magnet or induction, etc. in various embodiments, and the motor assembly 114 could have additional gearing therein. It is still further understood the motor assembly 114 is operated by electronics, i.e. electronic circuitry, of the printed circuit board 112.

Sensors 110, in this embodiment Hall effect sensors 110, are mounted to the printed circuit board 112 so as to orient in specific positions relative to the rotational shaft 104, with the printed circuit board 112 assembled to the housing 102. In turn, the magnet 108, more specifically in this embodiment a pot magnet 108, is mounted to or positioned fixedly on the rotational shaft 104. So, the Hall effect sensors 110 are arranged to sense or detect the pot magnet 108 and thus sense or detect rotational positioning of the rotational shaft 104, at specific discrete locations. In one embodiment, the Hall effect sensors 110 are arranged at 0°, 90° and 180° on the printed circuit board 112, relative to the rotational shaft 104. Relatedly, the Hall effect sensors 110 are arranged to detect 0°, 90° and 180° rotational positioning of the rotational shaft 104. In one embodiment, these angles of rotational positioning of the rotational shaft 104 correspond to the rotational shaft 104 operating a deadbolt to lock and unlock, e.g., moving the deadbolt to a locked position and moving the deadbolt to an unlocked position to lock and unlock a door. Supporting the flexibility of installation on various doors in various arrangements, e.g., the interior-facing component and deadbolt on the left for a left-hand swinging door, and the interior-facing component and deadbolt on the right for a right-hand swinging door (as seen by the user from the interior of the dwelling), these angles may correspond to 0° for a lock position in one installation, and 180° for a lock position in another installation. For example, 90° may correspond to an unlocked position for either type of installation, and the embodiment may include sensors 110 (e.g., magnet sensors, magnetic field sensors, Hall effect sensors) arranged to sense a lock position of 0° and a lock position of 180°, so that the manually and electronically operable deadbolt assembly is functional for a left-hand swinging door and functional for a right-hand swinging door.

In order to mate the rotational shaft 104 to a further mechanism for connection or coupling to and operation of the deadbolt, there is an engagement feature 116 defined on or in the rotational shaft 104, in various embodiments. Here, the engagement feature 116 is a dimensioned slot or keyway, which may have a “T” cross section or channel, and which could be splined internally or externally on the rotational shaft 104, or have other physical characteristics for positive engagement to a further mechanism.

FIG. 2 illustrates a further view of the interior-facing component of FIG. 1, featuring a deadbolt thumb turnpiece 202, in an embodiment. Of particular note, the deadbolt thumb turnpiece 202 is visible and manually accessible on an exterior of the component. In manual operation of a deadbolt, for example by a user locking or unlocking a deadbolt from the interior of a dwelling, the user grasps or otherwise physically manipulates the deadbolt thumb turnpiece 202, rotating (i.e., turning) the deadbolt thumb turnpiece 202 in one direction or another, to lock or unlock the deadbolt manually. In one embodiment, the rotational shaft 104 is directly connected to the deadbolt thumb turnpiece 202, for example by mechanical connection through an aperture of the housing 102, which may include a bearing, so that the rotational shaft 104 may be rotated from the exterior of the component and the rotational shaft 104 will be rotated correspondingly. In further embodiments, there could be a geared connection or other relationship between the rotational shaft 104 and the deadbolt thumb turnpiece 202, for manual operation of the deadbolt via the rotational shaft 104 and deadbolt thumb turnpiece 202. Also visible in FIG. 2 are a portion of the interior of the component, including the printed circuit board 112 and the aforementioned rotational shaft 104 in relationship to the deadbolt thumb turnpiece 202. It is understood, the printed circuit board 112 will be repositioned and installed to the housing 102, in proper relationship to the rotational shaft 104, for completion of assembly.

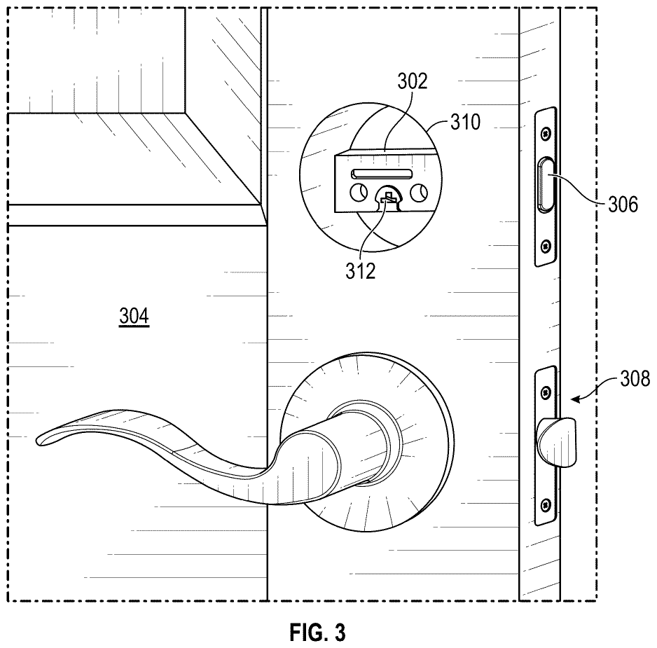

FIGS. 3-6 illustrate installation of a manually and electronically operable deadbolt assembly to a door 304. It should be appreciated that further components, further assembly steps, and/or variations may be applicable for this and other embodiments, and that the illustrations serve as examples for the relevant features and functionality thereof in relation to an end use (and installation) of a complete product, of which present embodiments may be a component.

FIG. 3 illustrates a deadbolt assembly 302, installed in a door 304, ready for installation of further components of a manually and electronically operable deadbolt assembly. An aperture 310 in the door 304 provides a space for installation of further components. On the right, a deadbolt 306 is visible, in an unlocked position. This may correspond to sensing 90° rotational positioning of the rotational shaft 104, as described above with reference to FIG. 2. It is appreciated that improvements to accuracy and repeatability of sensing herein correspond to reliable positioning of the rotational shaft 104 and corresponding positioning of the deadbolt 306 in the unlocked position (and also, in a locked position, for each type of swinging door, not shown but readily understood). A latch assembly 308 is shown, and readily understood as operable by a door handle to unlatch a door 304, and further operable to latch the door 304, as appropriate to further operation of the deadbolt 306 and interaction therewith.

Also visible in FIG. 3 is an engagement feature 312 of the deadbolt assembly 302, which in this embodiment is complementary to, symmetric with, or otherwise corresponding to the engagement feature 116 of the rotational shaft 104. Similarly, variations for further embodiments apply. It is understood that when the interior-facing component of FIGS. 1 and 2 is assembled to the deadbolt assembly 302, the rotational shaft 104 mates to a further mechanism such that the engagement feature 116 of the rotational shaft 104 aligns with the engagement feature 312 of the deadbolt assembly 302. And, functionally, rotating the rotational shaft 104 will rotate a corresponding portion of the deadbolt assembly 302, so as to extend and retract the deadbolt 306, to lock and unlock the door 304. In this embodiment, the shape or cross section of the engagement feature 312 of the deadbolt assembly 302 is similar or identical to the shape or cross section of the engagement feature 116 of the rotational shaft 104, and both are dimensioned and arranged to align to each other and to receive a still further mechanism as described below, for operation of the deadbolt 306.

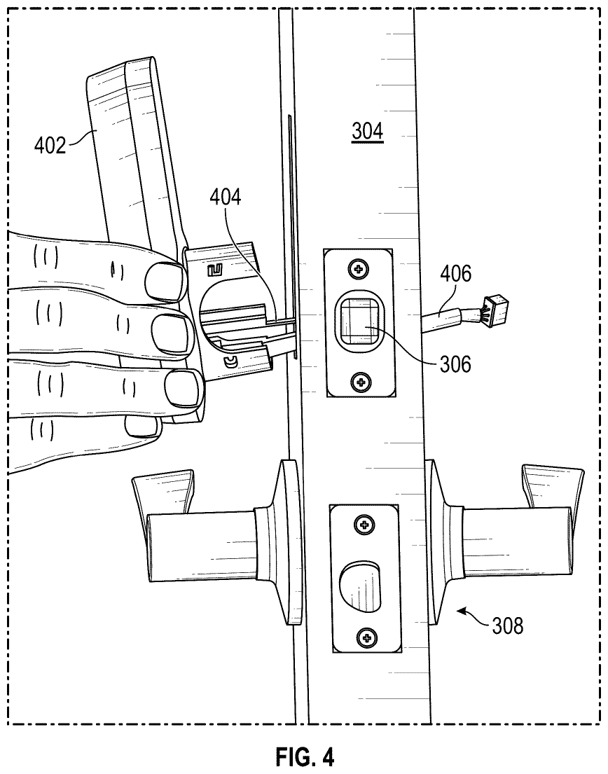

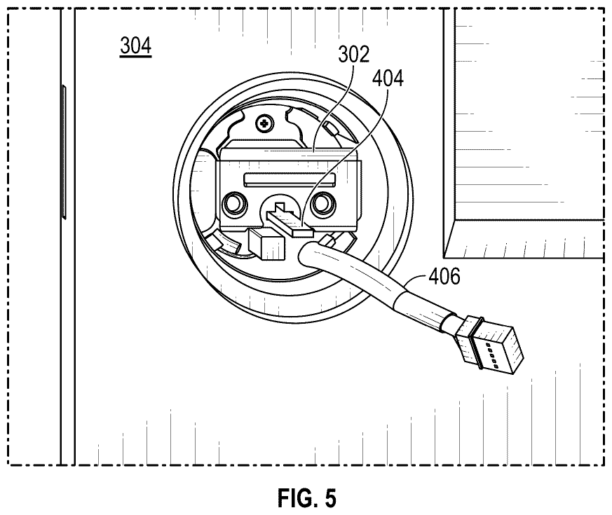

FIG. 4 illustrates an embodiment of an exterior-facing component 402 for a manually and electronically operable deadbolt assembly, showing installation to the door 304 and to the deadbolt assembly 302, of FIG. 3. The deadbolt 306 and latch assembly 308 are visible in this door-edge view, as are fingers of a user's hand installing the exterior-facing component 402. A further rotational shaft 404 is shown projecting from the exterior-facing component 402, and is engaging with the deadbolt assembly 302 as will be visible in FIG. 5. Also projecting from the exterior-facing component 402, is a wire 406 (e.g., a wire bundle with connector), which in one embodiment is used for communication with (or between) electronics in the exterior-facing component 402 and electronics in the interior-facing component of FIGS. 1 and 2 (see also FIGS. 5 and 6). For example, electronic circuitry in the exterior-facing component 402 may include a keypad, touchpad, touchscreen, buttons, biometrics detector, card scanner or other user interface for electronic operation of the deadbolt 306, e.g., unlocking the deadbolt from outside a dwelling, i.e., from the exterior-facing side of the door 304. Communication through the wire 406 may include data, command or instruction to operate the motor assembly 114, of the interior-facing component of FIGS. 1 and 2, to drive the gear 106 and rotational shaft 104, to operate the deadbolt assembly 302 and move the deadbolt 306.

In the embodiment illustrated in FIG. 4, the shape or cross section of the further rotational shaft 404 is flat, but could be “T” shaped, splined or have other engagement features in further embodiments. The importance (and function) of the shape is to engage engagement features 116, 312 of the rotational shaft 104 and deadbolt assembly 302, for operation of the deadbolt 306. Further engagement shapes and mechanisms are envisioned for further embodiments.

FIG. 5 illustrates a view of the interior-facing side of a door 304 with portions of the deadbolt assembly 302 of FIG. 3 and underside of the exterior-facing component 402 of FIG. 4 visible, ready to receive installation of the interior-facing component of FIGS. 1 and 2. Particularly, the further rotational shaft 404 is shown engaging the deadbolt assembly 302 and ready to engage the engagement feature 116 of the rotational shaft 104. Also, the wire 406 is shown ready to engage electronics of the interior-facing component, e.g., connection to a connector of or connected to the printed circuit board 112.

FIG. 6 illustrates installation of the interior-facing component of FIGS. 1 and 2 to the door 304 and other components, showing the deadbolt thumb turnpiece 202 as accessible for manual operation of the deadbolt 306 from the interior-facing side of the door 304. Particularly, the housing 102 is fastened, perhaps to a plate or other fixture and thereby to the door 304, or possibly directly to the door 304 in various embodiments. Although internal details are not visible in FIG. 6, it is understood the rotational shaft 104 (see FIG. 1) remains coupled to the deadbolt thumb turnpiece 202, and is now coupled to the further rotational shaft 404 (see FIG. 4), the deadbolt assembly 302 (see FIG. 3) and the deadbolt 306, through installation of the components of a manually and electronically operable deadbolt assembly to the door 304. Thus, the deadbolt 306 is operable manually, via the deadbolt thumb turnpiece 202 coupling mechanically to the deadbolt assembly 302, and the deadbolt 306 is operable electronically, through the printed circuit board 112 and motor assembly 114 driving the rotational shaft 104 and mechanical coupling thereby to the deadbolt assembly 302. Accurate sensing of rotational shaft 104 rotational positioning may be accomplished by the sensors 110 for either or both types of operation.

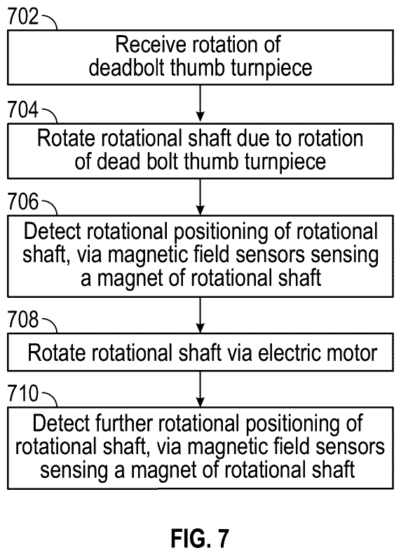

FIG. 7 illustrates an embodiment of a method of operation of a component for a manually and electronically operable deadbolt assembly. The method may be practiced by a component of a manually and electronically operable deadbolt assembly, for example embodiments described herein and variations thereof.

In an action 702, the component receives a rotation of a deadbolt thumb turnpiece, which is part of the component. For example, a user may manually rotate the deadbolt thumb turnpiece, to manually operate a deadbolt to lock or unlock a door.

In an action 704, a rotational shaft is rotated due to rotation of the deadbolt thumb turnpiece. For example, the rotational shaft is coupled to the deadbolt thumb turnpiece, as part of the component, and rotates with the rotation of the deadbolt thumb turnpiece.

In an action 706, the component detects rotational positioning of the rotational shaft, via magnetic field sensors sensing a magnet of the rotational shaft. For example, the magnetic field sensors that are part of the component may be Hall effect sensors, the magnet may be a pot magnet, embedded in a projecting portion of the rotational shaft, and the magnetic field sensors sense this magnet in association with rotation and rotational positioning of the rotational shaft.

In an action 708, the rotational shaft is rotated via an electric motor. For example, the electric motor is part of the component, and is mechanically coupled via gearing to the rotational shaft. These pieces and their specific arrangement may be part of the component.

In an action 710, the component detects further rotational positioning of the rotational shaft, via magnetic field sensors sensing a magnet of the rotational shaft. Such detection is comparable to the action 706, with related example. Actions 706 and 710 differ in the source of the rotation of the rotational shaft, being from preceding actions 704 and 708, respectively. Actions 704 and 708 respectively represent manual and electronically operable functionality of the component and the manually and electronically operable deadbolt assembly that includes the component.

Technological improvements of or for a component or components of a manually and electronically operable deadbolt assembly are described herein, relating to the use of sensors, specifically Hall effect sensors, a magnet, specifically a potted magnet, specific positioning of sensors, specific positioning of a magnet, specific angular detection of rotational positioning of a rotational shaft, sensitivity, accuracy, reliability and repeatability of sensing and detection, and further aspects of the embodiments and variations thereof. Such technological improvements may improve accuracy of deadbolt movement and positioning, may improve reliability of deadbolt operation, may apply to flexibility of installation of a product to left-hand swinging or right-hand swinging doors, may apply to self-calibration of a unit, may reduce manufacturing defects (e.g., decrease number of product testing rejects at manufacturing), may reduce product failure upon aging of components, and/or may have further benefits or advantages. Specifically referencing the title of the present application, such technological improvements may improve accuracy, sensitivity, reliability and/or repeatability of deadbolt thumb turnpiece position sensing.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A component for a manually and electronically operable deadbolt assembly, comprising:
a housing including a rotational shaft having at least one magnet and a plurality of magnet sensors arranged to sense the at least one magnet of the rotational shaft;
wherein the housing is dimensioned to assemble to an interior-facing side of a door, a deadbolt assembly and an exterior-facing component, for forming the manually and electronically operable deadbolt assembly.

2. The component of claim 1, wherein:
the housing further includes an electric motor arranged to turn the rotational shaft; and
positioning of the rotational shaft via the electric motor is detectable via the plurality of magnet sensors.

3. The component of claim 1, wherein:
the housing further includes a deadbolt thumb turnpiece coupled to the rotational shaft; and
manual operation of the deadbolt thumb turnpiece, the rotational shaft, and a deadbolt of the manually and electronically operable deadbolt assembly is detectable via the plurality of magnet sensors.

4. The component of claim 1, wherein the at least one magnet comprises a pot magnet of the rotational shaft.

5. The component of claim 1, wherein the plurality of magnet sensors comprises three sensors, arranged to detect 0°, 90° and 180° rotational positioning of the rotational shaft.

6. The component of claim 1, wherein the plurality of magnet sensors comprises three Hall effect sensors arranged at 0°, 90° and 180° on a circuit board, relative to the rotational shaft.

7. The component of claim 1, wherein the plurality of magnet sensors are arranged to sense a lock position of 0° and a lock position of 180°, so that the manually and electronically operable deadbolt assembly is functional for a left-hand swinging door and functional for a right-hand swinging door.

8. An interior-facing component for a manually and electronically operable deadbolt assembly, comprising:
a housing configured to assemble on an interior-facing side of a door to a deadbolt assembly, an exterior-facing component and the door, the housing including a rotational shaft having a pot magnet and a plurality of sensors arranged to sense the pot magnet and associated position of the rotational shaft;
wherein the rotational shaft is coupled to a deadbolt of the deadbolt assembly with operability to lock and unlock the door.

9. The interior-facing component of claim 8, wherein:
the rotational shaft further includes a gear; and
the housing further includes an electric motor arranged to turn the rotational shaft via the gear, wherein positioning of the rotational shaft is detectable via the plurality of sensors.

10. The interior-facing component of claim 8, wherein:
the housing further includes a deadbolt thumb turnpiece coupled to the rotational shaft; and
user operation of the deadbolt thumb turnpiece, the rotational shaft, and the deadbolt is detectable via the plurality of Hall effect sensors.

11. The interior-facing component of claim 8, wherein the pot magnet is embedded in a protruding region of the rotational shaft.

12. The interior-facing component of claim 8, wherein the plurality of sensors comprises three Hall effect sensors, arranged to detect 0°, 90° and 180° rotational positioning of the rotational shaft.

13. The interior-facing component of claim 8, wherein:
the plurality of sensors comprises a first Hall effect sensor arranged at 0°, a second Hall effect sensor arranged at 90°, and a third Hall effect sensor arranged at 180°, on a circuit board, relative to the rotational shaft.

14. The interior-facing component of claim 8, wherein:
the plurality of sensors are arranged to sense a lock position of 0° and a lock position of 180°, wherein the interior-facing component is functional for an interior side of a left-hand swinging door and functional for an interior side of a right-hand swinging door.

15. A method of operation of a component for a manually and electronically operable deadbolt assembly, practiced by the component, the method comprising:
receiving rotation of a deadbolt thumb turnpiece that is rotatably mounted to a housing and coupled to a rotational shaft;
rotating the rotational shaft, due to such coupling of the rotational shaft and the deadbolt thumb turnpiece and due to such rotation of the deadbolt thumb turnpiece; and
detecting rotational positioning of the rotational shaft from the rotation of the deadbolt thumb turnpiece, via a plurality of magnetic field sensors arranged within the housing to sense a magnet of the rotational shaft.

16. The method of claim 15, further comprising:
rotating the rotational shaft via an electric motor arranged within the housing; and
detecting further rotational positioning of the rotational shaft via the plurality of magnetic field sensors, from the rotating via the electric motor.

17. The method of claim 16, wherein:
detecting the rotational positioning of the rotational shaft and detecting the further rotational positioning of the rotational shaft each comprises sensing, by the plurality of magnetic field sensors, a pot magnet of the rotational shaft.

18. The method of claim 16, wherein detecting the rotational positioning of the rotational shaft and detecting the further rotational positioning of the rotational shaft each comprises sensing by three Hall effect sensors, as the plurality of magnetic field sensors, arranged to detect 0°, 90° and 180° rotational positioning of the rotational shaft.

19. The method of claim 16, wherein detecting the rotational positioning of the rotational shaft and detecting the further rotational positioning of the rotational shaft each comprises sensing by three Hall effect sensors, as the plurality of magnetic field sensors, arranged at 0°, 90° and 180° on a circuit board, relative to the rotational shaft.

20. The method of claim 16, wherein detecting the rotational positioning of the rotational shaft and detecting the further rotational positioning of the rotational shaft each comprises sensing by three Hall effect sensors, as the plurality of magnetic field sensors, arranged to sense a lock position of 0° and a lock position of 180°.
